(19) United States
(12) Patent Application Publication
(10) Pub. No.: US 2025/0022201 A1
(43) Pub. Date: Jan. 16, 2025

(54) SPECIAL EFFECT VIDEO GENERATION METHOD AND APPARATUS, DEVICE, AND STORAGE MEDIUM

(71) Applicant: Beijing Bytedance Network Technology Co., Ltd., Beijing (CN)

(72) Inventor: Panpan XU, Beijing (CN)

(21) Appl. No.: 18/715,079

(22) PCT Filed: Nov. 29, 2022
(86) PCT No.: PCT/CN2022/135046

§ 371 Date: May 30, 2024

(30) Foreign Application Priority Data
Nov. 30, 2021 (CN) 202111448252.7

(51) Int. Cl. G06T 13/40; G06T 17/00; H04N 21/234

(52) U.S. Cl. CPC G06T 13/40; G06T 17/00; H04N 21/23424

(57) ABSTRACT

Embodiments of the present disclosure disclose a special effect video generation method and apparatus, a device, and a storage medium. One person portrait image or a plurality of person portrait images are acquired, and a special effect information sequence is obtained. The one person portrait image and the special effect information sequence are input into a first special effect generation model, or the plurality of person portrait images and the special effect information sequence are input into the first special effect generation model, to obtain a plurality of special effect images. The plurality of special effect images are stitched in the set order, to obtain a target special effect video.

The present application claims priority to Chinese Patent Application No. 202111448252.7, filed with the China National Intellectual Property Administration on Nov. 30, 2021, which is incorporated herein by reference in its entirety.

### TECHNICAL FIELD

Embodiments of the present disclosure relate to the field of image processing technologies, and for example, to a special effect video generation method and apparatus, a device, and a storage medium.

### BACKGROUND ART

In recent years, short video apps have developed rapidly, entering users' lives and gradually enriching their spare time. The users may record their lives by means of videos, photos, etc., which may be reprocessed using special effect technologies, such as beauty, style, expression editing, etc., provided on the short video apps for presentation in richer forms.

### SUMMARY OF THE INVENTION

Embodiments of the present disclosure provide a special effect video generation method and apparatus, a device, and a storage medium, which may make a video more interesting and improve user experience.

According to a first aspect, an embodiment of the present disclosure provides a special effect video generation method. The method includes:
acquiring one person portrait image or a plurality of person portrait images, and obtaining a special effect information sequence, where special effect information in the special effect information sequence is arranged in a set order;
inputting the one person portrait image and the special effect information sequence into a first special effect generation model, or inputting the plurality of person portrait images and the special effect information sequence into the first special effect generation model, to obtain a plurality of special effect images; and
stitching the plurality of special effect images in the set order, to obtain a target special effect video.

According to a second aspect, an embodiment of the present disclosure further provides a special effect video generation apparatus. The apparatus includes:
a person portrait image acquisition module configured to acquire one person portrait image or a plurality of person portrait images, and obtain a special effect information sequence, where special effect information in the special effect information sequence is arranged in a set order;
a special effect image obtaining module configured to input the one person portrait image and the special effect information sequence into a first special effect generation model, or input the plurality of person portrait images and the special effect information sequence into the first special effect generation model, to obtain a plurality of special effect images; and
a target special effect video obtaining module configured to stitch the plurality of special effect images in the set order, to obtain a target special effect video.

According to a third aspect, an embodiment of the present disclosure further provides an electronic device. The electronic device includes:
at least one processing apparatus;
a storage apparatus configured to store at least one program, where
the at least one program, when executed by the at least one processing apparatus, causes the at least one processing apparatus to implement the special effect video generation method according to the embodiment of the present disclosure.

According to a fourth aspect, an embodiment of the present disclosure further provides a computer-readable medium having stored thereon a computer program that, when executed by a processing apparatus, causes the special effect video generation method according to the embodiment of the present disclosure to be implemented.

According to a fifth aspect, an embodiment of the present disclosure further provides a computer program product that, when executed by a computer, causes the computer to implement the special effect video generation method according to the embodiment of the present disclosure.

### BRIEF DESCRIPTION OF DRAWINGS

FIG. 1 is a flowchart of a special effect video generation method according to an embodiment of the present disclosure;

FIG. 2 shows images of different degrees of a “sticking tongue out” special effect according to an embodiment of the present disclosure;

FIG. 3 is a schematic diagram of a structure of a special effect video generation apparatus according to an embodiment of the present disclosure; and

FIG. 4 is a schematic diagram of a structure of an electronic device according to an embodiment of the present disclosure.

### DETAILED DESCRIPTION OF THE INVENTION

Embodiments of the present disclosure are described in more detail below with reference to the accompanying drawings.

It should be understood that the various steps described in the method implementations of the present disclosure may be performed in different orders, and/or performed in parallel. Furthermore, additional steps may be included and/or the execution of the illustrated steps may be omitted in the method implementations. The scope of the present disclosure is not limited in this respect.

The term “include/comprise” used herein and the variations thereof are an open-ended inclusion, namely, “include/comprise but not limited to”. The term “based on” is “at least partially based on”. The term “an embodiment” means “at least one embodiment”. The term “another embodiment” means “at least one another embodiment”. The term “some embodiments” means “at least some embodiments”. Related definitions of the other terms will be given in the description below.

It should be noted that concepts such as “first” and “second” mentioned in the present disclosure are only used to distinguish different apparatuses, modules, or units, and are not used to limit the sequence of functions performed by these apparatuses, modules, or units or interdependence.

It should be noted that the modifiers “one” and “a plurality of” mentioned in the present disclosure are illustrative and not restrictive, and those skilled in the art should understand that unless the context clearly indicates otherwise, the modifiers should be understood as “at least one”.

The names of messages or information exchanged between a plurality of apparatuses in the implementations of the present disclosure are used for illustrative purposes only, and are not used to limit the scope of these messages or information.

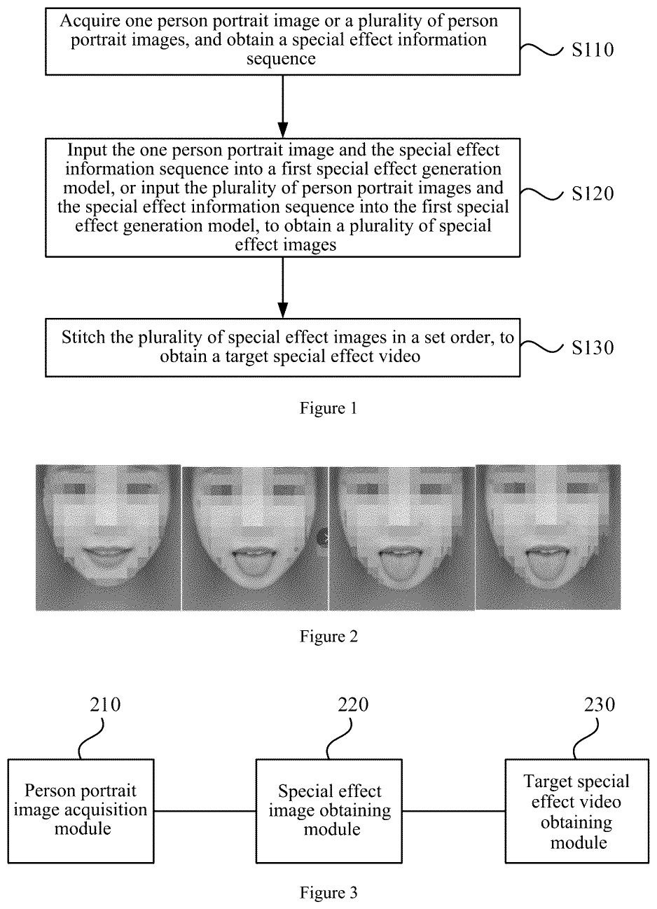

FIG. 1 is a flowchart of a special effect video generation method according to an embodiment of the present disclosure. This embodiment is applicable to a case of generating a special effect video. The method may be performed by a special effect video generation apparatus. The apparatus may be composed of hardware and/or software, and may generally be integrated into a device having a special effect video generation function. The device may be an electronic device such as a server, a mobile terminal, or a server cluster. As shown in FIG. 1, the method includes the following steps.

Step 110: Acquire one person portrait image or a plurality of person portrait images, and obtain a special effect information sequence.

Special effect information in the special effect information sequence is arranged in a set order. The set order may be an order from high to low or from low to high in terms of degrees of the special effect. For example, assuming that the special effect is a “sticking tongue out” special effect, the special effect information represents a degree of “sticking tongue out” by a person. In this embodiment, the special effect information may be represented in the form of numeric code. For example, the special effect information may be represented as a value from 0 to 1, where “0” represents the lowest degree, and “1” represents the highest degree. Assuming that the special effect is the “sticking tongue out” special effect, “0” represents that the person does not stick the tongue out, and “1” represents the maximum degree of sticking the tongue out. The special effect information sequence may be a sequence consisting of equally spaced numerical values from 0 to 1.

In this embodiment, the one person portrait image or the plurality of person portrait images may be acquired by using a camera of the mobile terminal. For example, portraits of a person are shot to obtain the plurality of person portrait images.

Step 120: Input the one person portrait image and the special effect information sequence into a first special effect generation model, or input the plurality of person portrait images and the special effect information sequence into the first special effect generation model, to obtain a plurality of special effect images.

If one person portrait image is acquired, the one person portrait image and the special effect information sequence are input into the first special effect generation model, to obtain the plurality of special effect images. If a plurality of person portrait images are acquired, the plurality of person portrait images and the special effect information sequence are grouped into a plurality of special effect data pairs, and the plurality of special effect data pairs are input into the first special effect generation model in sequence, to obtain the plurality of special effect images. The special effect data pair consists of one person portrait image and one piece of special effect information, and the grouped plurality of special effect data pairs are arranged in order of the special effect information in the special effect information sequence.

The first special effect generation model may be obtained by training a generative adversarial network. For example, a person portrait image corresponding to special effect information may be obtained by inputting a special effect data pair consisting of the person portrait image and the special effect information into the first special effect generation model. For example, it is assumed that the special effect is the “sticking tongue out” special effect. FIG. 2 shows images of different degrees of the “sticking tongue out” special effect. It can be seen from FIG. 2 that the degrees of “sticking tongue out” increase from left to right.

Optionally, the first special effect generation model is trained by: obtaining person portrait sample data; inputting the person portrait sample data and key point difference information into a second special effect generation model, to obtain first special effect data; encoding a degree of the first special effect data to obtain special effect information corresponding to the first special effect data; inputting the person portrait sample data and the special effect information into the first special effect generation model, to obtain second special effect data; and training the first special effect generation model based on a loss function between the first special effect data and the second special effect data.

The person portrait sample data may be neutral expression data of the person, i.e., a person portrait image without a special effect. For example, obtaining the person portrait sample data may be: acquiring a real person portrait to obtain the person portrait sample data; or rendering a virtual person portrait to obtain the person portrait sample data; or inputting random noise into a person portrait generation model to obtain the person portrait sample data.

The real person portrait may be acquired from different angles and/or under different light conditions. In this embodiment, the person portrait sample data is obtained in various manners, which may increase the diversity of samples.

The key point difference information may be a difference between key point information in the person portrait sample data and key point information in the first special effect data. The key point difference information may be obtained in advance by calculating a difference between key point information in the person portrait image with special effect information of “0” and key point information in the person portrait image with special effect information of “m”, where m is a numerical value greater than 0 and less than or equal to 1. The key point information may be represented by a matrix or a vector, and thus, the key point difference information is a difference between two matrices or vectors.

Encoding the degree of the first special effect data requires encoding based on the key point difference information. If the key point difference information is the difference between the key point information in the person portrait image with the special effect information of “0” and the key point information in the person portrait image with the special effect information of “m”, the special effect information of the first special effect data is encoded as m.

In this embodiment, the second special effect data may be obtained by the first special effect generation model based on the input person portrait sample data and special effect information. This process may be expressed as M (alpha, A)=B, where M represents the first special effect generation model, alpha represents the special effect information, A represents the person portrait sample data, and B represents the second special effect data. In this embodiment, the first special effect generation model is trained based on the first special effect data output from the second special effect generation model, which can reduce an amount of computation of the first special effect generation model, thereby increasing the efficiency of generating special effect images, and facilitating deployment of the first special effect generation model on the mobile terminal.

In this embodiment, the second special effect generation model is also constructed by the generative adversarial network, and a number of channels and/or network layers of the first special effect generation model is less than that of the second special effect generation model. Deployment of the second special effect generation model on a server may save system resources of the mobile terminal.

Optionally, the second special effect generation model is trained by: obtaining virtual person special effect video data and real person special effect video data; extracting two video frames from the virtual person special effect video data to form a virtual video frame pair, and extracting two video frames from the real person special effect video data to form a real video frame pair; training the second special effect generation model based on the virtual video frame pair; and rectifying the trained second special effect generation model based on the real video frame.

The virtual person special effect video data may be obtained by using a set rendering tool, and the real person special effect video data may be obtained by acquiring a video of a real person performing a special effect action. Extracting two video frames from each of the virtual person special effect video data and the real person special effect video data may be understood as extracting two video frames at random from each of the virtual person special effect video data and the real person special effect video data. In this embodiment, the virtual person special effect video data is easy to obtain and aesthetically pleasing, but is not authentic enough, while the real person special effect video data is hard to acquire and not aesthetically pleasing enough, but is authentic. Therefore, the second special effect generation model is trained based on the virtual video frame pair, and the trained second special effect generation model is rectified based on the real video frame pair, which may ensure the authenticity and aesthetics of the second special effect generation model.

The virtual video frame pair includes a forward virtual video frame and a backward virtual video frame. For example, a process of training the second special effect generation model based on the virtual video frame pair may include: extracting key point information from each of the forward virtual video frame and the backward virtual video frame to obtain forward virtual key point information and backward virtual key point information; determining first difference information between the forward virtual key point information and the backward virtual key point information; inputting the first difference information and the forward virtual video frame into the second special effect generation model, to obtain third special effect data; and training the second special effect generation model based on a loss function between the backward virtual video frame and the third special effect data.

The forward virtual video frame may be understood as a video frame earlier in terms of chronological order in the virtual person special effect video data, and the backward virtual video frame may be understood as a video frame later in terms of chronological order in the virtual person special effect video data. The key point information may be understood as facial key point information, and may be implemented using any key point extraction algorithm in the related art, which is not limited here. In this embodiment, assuming that the forward virtual video frame is represented as D1, the backward virtual video frame is represented as D2, the forward virtual key point information is represented as D1.key, and the backward virtual key point information is represented as D2.key, a training process of the second special effect generation model may be expressed as F (D1, D1.key−D2.key)=D3, where D3 represents the third special effect data. Then, a loss function between D2 and D3 is calculated, and the second special effect generation model is trained based on the loss function. In this embodiment, the second special effect generation model is trained based on the virtual video frame pair, which may improve the aesthetics of the special effect data generated by the second special effect generation model.

The real video frame pair includes a forward real video frame and a backward real video frame. For example, the trained second special effect generation model may be rectified based on the real video frame pair by: extracting key point information from each of the forward real video frame and the backward real video frame, to obtain forward real key point information and backward real key point information; determining second difference information between the forward real key point information and the backward real key point information; inputting the second difference information and the forward real video frame into the trained second special effect generation model, to obtain fourth special effect data; and rectifying the trained second special effect generation model based on a loss function between the backward real video frame and the fourth special effect data.

The forward real video frame may be understood as a video frame having an earlier timestamp in the real person special effect video data, and the backward real video frame may be understood as a video frame having a later timestamp in the real person special effect video data. The key point information may be understood as facial key point information, and may be implemented using any key point extraction algorithm in the related art, which is not limited here. In this embodiment, assuming that the forward real video frame is represented as D4, the backward real video frame is represented as D5, the forward real key point information is represented as D4.key, and the backward real key point information is represented as D5.key, a training process of the second special effect generation model may be expressed as F (D4, D4.key−D5.key)=D6, where D6 represents the fourth special effect data. Then, a loss function between D5 and D6 is calculated, and the second special effect generation model is rectified based on the loss function. In this embodiment, the trained second special effect generation model is rectified based on the real video frame pair, which may improve the authenticity of the special effect data generated by the second special effect generation model, while ensuring the aesthetics of such special effect data.

Step 130: Stitch the plurality of special effect images in the set order, to obtain a target special effect video.

For example, after the plurality of special effect images are obtained, the plurality of special effect images are stitched and encoded in the set order, to obtain the target special effect video.

In the technical solution of this embodiment of the present disclosure, the one person portrait image or the plurality of person portrait images are acquired, and the special effect information sequence is obtained, where the special effect information in the special effect information sequence is arranged in the set order; the one person portrait image and the special effect information sequence are input into the first special effect generation model, or the plurality of person portrait images and the special effect information sequence are input into the first special effect generation model, to obtain the plurality of special effect images; and the plurality of special effect images are stitched in the set order, to obtain the target special effect video. In the special effect video generation method provided in this embodiment of the present disclosure, the one person portrait image and the special effect information sequence are input into the first special effect generation model, or the plurality of person portrait images and the special effect information sequence are input into the first special effect generation model, to obtain the special effect images, thereby obtaining the target special effect video. In this way, images can be made more interesting, and user experience can be improved.

FIG. 3 is a schematic diagram of a structure of a special effect video generation apparatus according to an embodiment of the present disclosure. As shown in FIG. 3, the apparatus includes:
a person portrait image acquisition module 210 configured to acquire one person portrait image or a plurality of person portrait images, and obtain a special effect information sequence, where special effect information in the special effect information sequence is arranged in a set order;
a special effect image obtaining module 220 configured to input the one person portrait image and the special effect information sequence into a first special effect generation model, or input the plurality of person portrait images and the special effect information sequence into the first special effect generation model, to obtain a plurality of special effect images; and
a target special effect video obtaining module 230 configured to stitch the plurality of special effect images in the set order, to obtain a target special effect video.

Optionally, the special effect image obtaining module 220 is further configured to:
group the plurality of person portrait images and the special effect information sequence into a plurality of special effect data pairs, where the special effect data pair consists of one person portrait image and one piece of special effect information; and
input the plurality of special effect data pairs into the first special effect generation model in sequence, to obtain the plurality of special effect images.

Optionally, the apparatus further includes a first special effect generation model training module configured to:
obtain person portrait sample data;
input the person portrait sample data and key point difference information into a second special effect generation model, to obtain first special effect data;
encode the first special effect data to obtain special effect information corresponding to the first special effect data;
input the person portrait sample data and the special effect information into the first special effect generation model, to obtain second special effect data; and
train the first special effect generation model based on a loss function between the first special effect data and the second special effect data.

Optionally, the first special effect generation model training module is further configured to:
acquire a real person portrait to obtain the person portrait sample data; or
render a virtual person portrait to obtain the person portrait sample data; or
input random noise into a person portrait generation model to obtain the person portrait sample data.

Optionally, the apparatus further includes a second special effect generation model training module configured to:
obtain virtual person special effect video data and real person special effect video data;
extract two video frames from the virtual person special effect video data to form a virtual video frame pair, and extract two video frames from the real person special effect video data to form a real video frame pair;
train the second special effect generation model based on the virtual video frame pair; and
rectify the trained second special effect generation model based on the real video frame pair.

Optionally, the virtual video frame pair includes a forward virtual video frame and a backward virtual video frame; and the second special effect generation model training module is further configured to:
extract key point information from each of the forward virtual video frame and the backward virtual video frame to obtain forward virtual key point information and backward virtual key point information;
determine first difference information between the forward virtual key point information and the backward virtual key point information;
input the first difference information and the forward virtual video frame into the second special effect generation model, to obtain third special effect data; and
train the second special effect generation model based on a loss function between the backward virtual video frame and the third special effect data.

Optionally, the real video frame pair includes a forward real video frame and a backward real video frame, and the second special effect generation model training module is further configured to:
extract key point information from each of the forward real video frame and the backward real video frame, to obtain forward real key point information and backward real key point information;
determine second difference information between the forward real key point information and the backward real key point information;
input the second difference information and the forward real video frame into the trained second special effect generation model, to obtain fourth special effect data; and
rectify the trained second special effect generation model based on a loss function between the backward real video frame and the fourth special effect data.

Optionally, the first special effect generation model and the second special effect generation model are both constructed using a generative adversarial network, and a number of channels and/or network layers of the first special effect generation model is less than that of the second special effect generation model.

The apparatus described above can perform the method provided in all the above embodiments of the present disclosure, and has corresponding functional modules for performing the method described above. For the technical details not described in detail in this embodiment, reference may be made to the method provided in all the above embodiments of the present disclosure.

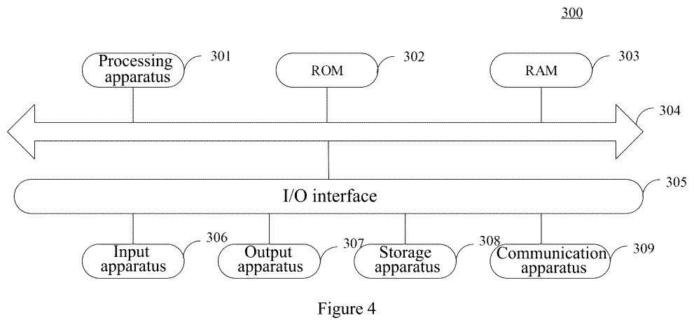

Reference is made to FIG. 4 below, which is a schematic diagram of a structure of an electronic device 300 suitable for implementing the embodiments of the present disclosure. The electronic device in this embodiment of the present disclosure may include, but is not limited to, mobile terminals such as a mobile phone, a notebook computer, a digital broadcast receiver, a personal digital assistant (PDA), a tablet computer (PAD), a portable multimedia player (PMP), and a vehicle-mounted terminal (such as a vehicle navigation terminal), and fixed terminals such as a digital television (TV) and a desktop computer, or various forms of servers such as a separate server or a server cluster. The electronic device shown in FIG. 4 is merely an example, and shall not impose any limitation on the function and scope of use of the embodiments of the present disclosure.

As shown in FIG. 4, the electronic device 300 may include a processing apparatus (e.g., a central processing unit, a graphics processing unit, etc.) 301 that may perform a variety of appropriate actions and processing in accordance with a program stored in a read-only memory (ROM) 302 or a program loaded from a storage apparatus 305 into a random access memory (RAM) 303. The RAM 303 further stores various programs and data required for the operation of the electronic device 300. The processing apparatus 301, the ROM 302, and the RAM 303 are connected to each other through a bus 304. An input/output (I/O) interface 305 is also connected to the bus 304.

Generally, the following apparatuses may be connected to the I/O interface 305: an input apparatus 306 including, for example, a touch screen, a touchpad, a keyboard, a mouse, a camera, a microphone, an accelerometer, and a gyroscope; an output apparatus 307 including, for example, a liquid crystal display (LCD), a speaker, and a vibrator; a storage apparatus 308 including, for example, a tape and a hard disk; and a communication apparatus 309. The communication apparatus 309 may allow the electronic device 300 to perform wireless or wired communication with other devices to exchange data. Although FIG. 4 shows the electronic device 300 having various apparatuses, it should be understood that it is not required to implement or have all of the shown apparatuses. It may be an alternative to implement or have more or fewer apparatuses.

In particular, according to an embodiment of the present disclosure, the process described above with reference to the flowcharts may be implemented as a computer software program. For example, this embodiment of the present disclosure includes a computer program product, which includes a computer program carried on a computer-readable medium, where the computer program includes program code for performing the special effect video generation method in the embodiments of the present disclosure. In such an embodiment, the computer program may be downloaded from a network through the communication apparatus 309 and installed, installed from the storage apparatus 305, or installed from the ROM 302. When the computer program is executed by the processing apparatus 301, the above-mentioned functions defined in the method of the embodiment of the present disclosure are performed.

It should be noted that the above computer-readable medium described in the present disclosure may be a computer-readable signal medium, or a computer-readable storage medium, or any combination thereof. The computer-readable storage medium may be, for example but not limited to, electric, magnetic, optical, electromagnetic, infrared, or semiconductor systems, apparatuses, or devices, or any combination thereof. A more specific example of the computer-readable storage medium may include, but is not limited to: an electrical connection having at least one wire, a portable computer magnetic disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof. In the present disclosure, the computer-readable storage medium may be any tangible medium containing or storing a program which may be used by or in combination with an instruction execution system, apparatus, or device. In the present disclosure, the computer-readable signal medium may include a data signal propagated in a baseband or as a part of a carrier, the data signal carrying computer-readable program code. The propagated data signal may be in various forms, including but not limited to an electromagnetic signal, an optical signal, or any suitable combination thereof. The computer-readable signal medium may also be any computer-readable medium other than the computer-readable storage medium. The computer-readable signal medium can send, propagate, or transmit a program used by or in combination with an instruction execution system, apparatus, or device. The program code contained in the computer-readable medium may be transmitted by any suitable medium, including but not limited to: electric wires, optical cables, radio frequency (RF), etc., or any suitable combination thereof.

In some implementations, the client and the server can communicate using any currently known or future-developed network protocol such as a HyperText Transfer Protocol (HTTP), and can be connected to digital data communication (for example, communication network) in any form or medium. Examples of the communication network include a local area network (LAN), a wide area network (WAN), an internetwork (for example, the Internet), a peer-to-peer network (for example, an ad hoc peer-to-peer network), and any currently known or future-developed network.

The above computer-readable medium may be contained in the above electronic device. Alternatively, the computer-readable medium may exist independently, without being assembled into the electronic device.

The above computer-readable medium carries at least one program, and the at least one program, when executed by the electronic device, causes the electronic device to: acquire one person portrait image or a plurality of person portrait images, and obtain a special effect information sequence, where special effect information in the special effect information sequence is arranged in a set order; input the one person portrait image and the special effect information sequence into a first special effect generation model, or input the plurality of person portrait images and the special effect information sequence into the first special effect generation model, to obtain a plurality of special effect images; and stitch the plurality of special effect images in the set order, to obtain a target special effect video.

Computer program code for performing operations of the present disclosure can be written in one or more programming languages or a combination thereof, where the programming languages include but are not limited to object-oriented programming languages, such as Java, Smalltalk, and C++, and further include conventional procedural programming languages, such as “C” language or similar programming languages. The program code may be completely executed on a computer of a user, partially executed on a computer of a user, executed as an independent software package, partially executed on a computer of a user and partially executed on a remote computer, or completely executed on a remote computer or server. In the circumstance involving a remote computer, the remote computer may be connected to a computer of a user over any type of network, including a local area network (LAN) or a wide area network (WAN), or may be connected to an external computer (for example, connected over the Internet using an Internet service provider).

The flowcharts and block diagrams in the accompanying drawings illustrate the possibly implemented architecture, functions, and operations of the system, method, and computer program product according to various embodiments of the present disclosure. In this regard, each block in the flowchart or block diagram may represent a module, program segment, or part of code, and the module, program segment, or part of code contains at least one executable instruction for implementing the specified logical functions. It should also be noted that, in some alternative implementations, the functions marked in the blocks may also occur in an order different from that marked in the accompanying drawings. For example, two blocks shown in succession can actually be performed substantially in parallel, or they can sometimes be performed in the reverse order, depending on the functions involved. It should also be noted that each block in the block diagram and/or the flowchart, and a combination of the blocks in the block diagram and/or the flowchart may be implemented by a dedicated hardware-based system that executes specified functions or operations, or may be implemented by a combination of dedicated hardware and computer instructions.

The related units described in the embodiments of the present disclosure may be implemented by means of software, or may be implemented by means of hardware. The name of a unit does not constitute a limitation on the unit itself under certain circumstances.

The functions described herein above may be performed at least partially by at least one hardware logic component. For example, without limitation, exemplary types of hardware logic components that may be used include: a field programmable gate array (FPGA), an application specific integrated circuit (ASIC), an application specific standard product (ASSP), a system-on-chip (SOC), a complex programmable logic device (CPLD), and the like.

In the context of the present disclosure, a machine-readable medium may be a tangible medium that may contain or store a program used by or in combination with an instruction execution system, apparatus, or device. A machine-readable medium may be a machine-readable signal medium or a machine-readable storage medium. A machine-readable medium may include, but is not limited to, electronic, magnetic, optical, electromagnetic, infrared, or semiconductor systems, apparatus, or devices, or any suitable combination thereof. More specific examples of a machine-readable storage medium may include an electrical connection based on at least one wire, a portable computer disk, a hard disk, a random access memory (RAM), a read-only memory (ROM), an erasable programmable read-only memory (EPROM or flash memory), an optic fiber, a portable compact disk read-only memory (CD-ROM), an optical storage device, a magnetic storage device, or any suitable combination thereof.

According to at least one embodiment of the embodiments of the present disclosure, this embodiment of the present disclosure discloses a special effect video generation method. The method includes:
acquiring one person portrait image or a plurality of person portrait images, and obtaining a special effect information sequence, where special effect information in the special effect information sequence is arranged in a set order;
inputting the one person portrait image and the special effect information sequence into a first special effect generation model, or inputting the plurality of person portrait images and the special effect information sequence into the first special effect generation model, to obtain a plurality of special effect images; and
stitching the plurality of special effect images in the set order, to obtain a target special effect video.

Optionally, inputting the plurality of person portrait images and the special effect information sequence into the first special effect generation model, to obtain the plurality of special effect images includes:
grouping the plurality of person portrait images and the special effect information sequence into a plurality of special effect data pairs, where the special effect data pair consists of one person portrait image and one piece of special effect information; and
inputting the plurality of special effect data pairs into the first special effect generation model in sequence to obtain the plurality of special effect images.

Optionally, the first special effect generation model is trained by:
obtaining person portrait sample data;
inputting the person portrait sample data and key point difference information into a second special effect generation model, to obtain first special effect data;
encoding a degree of the first special effect data to obtain special effect information corresponding to the first special effect data;
inputting the person portrait sample data and the special effect information into the first special effect generation model, to obtain second special effect data; and
training the first special effect generation model based on a loss function between the first special effect data and the second special effect data.

Optionally, obtaining the person portrait sample data includes:
acquiring a real person portrait to obtain the person portrait sample data; or
rendering a virtual person portrait to obtain the person portrait sample data; or
inputting random noise into a person portrait generation model to obtain the person portrait sample data.

Optionally, the second special effect generation model is trained by:
obtaining virtual person special effect video data and real person special effect video data;
extracting two video frames from the virtual person special effect video data to form a virtual video frame pair, and extracting two video frames from the real person special effect video data to form a real video frame pair;
training the second special effect generation model based on the virtual video frame pair; and
rectifying the trained second special effect generation model based on the real video frame pair.

Optionally, the virtual video frame pair includes a forward virtual video frame and a backward virtual video frame; and training the second special effect generation model based on the virtual video frame pair includes:
extracting key point information from each of the forward virtual video frame and the backward virtual video frame to obtain forward virtual key point information and backward virtual key point information;
determining first difference information between the forward virtual key point information and the backward virtual key point information;
inputting the first difference information and the forward virtual video frame into the second special effect generation model, to obtain third special effect data; and
training the second special effect generation model based on a loss function between the backward virtual video frame and the third special effect data.

Optionally, the real video frame pair includes a forward real video frame and a backward real video frame, and rectifying the trained second special effect generation model based on the real video frame pair includes:
extracting key point information from each of the forward real video frame and the backward real video frame to obtain forward real key point information and backward real key point information;
determining second difference information between the forward real key point information and the backward real key point information;
inputting the second difference information and the forward real video frame into the trained second special effect generation model, to obtain fourth special effect data; and
rectify the trained second special effect generation model based on a loss function between the backward real video frame and the fourth special effect data.

Optionally, the first special effect generation model and the second special effect generation model are both constructed using a generative adversarial network, and a number of channels and/or network layers of the first special effect generation model is less than that of the second special effect generation model.

According to at least one embodiment of the embodiments of the present disclosure, this embodiment of the present disclosure discloses a special effect video generation apparatus. The apparatus includes:

a person portrait image acquisition module configured to acquire one person portrait image or a plurality of person portrait images, and obtain a special effect information sequence, where special effect information in the special effect information sequence is arranged in a set order;
a special effect image obtaining module configured to input the one person portrait image and the special effect information sequence into a first special effect generation model, or input the plurality of person portrait images and the special effect information sequence into the first special effect generation model, to obtain a plurality of special effect images; and
a target special effect video obtaining module configured to stitch the plurality of special effect images in the set order, to obtain a target special effect video.

According to at least one embodiment of the embodiments of the present disclosure, this embodiment of the present disclosure discloses an electronic device. The electronic device includes:
at least one processing apparatus;
a storage apparatus configured to store at least one program, where
the at least one program, when executed by the at least one processing apparatus, causes the at least one processing apparatus to implement the special effect video generation method according to any one of the embodiments described above.

According to at least one embodiment of the embodiments of the present disclosure, this embodiment of the present disclosure discloses a computer-readable medium having stored thereon a computer program that, when executed by a processing apparatus, causes the special effect video generation method according to any one of the embodiments described above to be implemented.

According to at least one embodiment of the embodiments of the present disclosure, this embodiment of the present disclosure discloses a computer program product that, when executed by a computer, causes the computer to implement the special effect video generation method according to the embodiments of the present disclosure.

1. A special effect video generation method, comprising:
acquiring one person portrait image or a plurality of person portrait images, and obtaining a special effect information sequence, wherein special effect information in the special effect information sequence is arranged in a set order;
inputting the one person portrait image and the special effect information sequence into a first special effect generation model, or inputting the plurality of person portrait images and the special effect information sequence into the first special effect generation model, to obtain a plurality of special effect images; and
stitching the plurality of special effect images in the set order, to obtain a target special effect video.

2. The method according to claim 1, wherein inputting the plurality of person portrait images and the special effect information sequence into the first special effect generation model, to obtain the plurality of special effect images comprises:
grouping the plurality of person portrait images and the special effect information sequence into a plurality of special effect data pairs, wherein the special effect data pair consists of one person portrait image and one piece of special effect information; and
inputting the plurality of special effect data pairs into the first special effect generation model in sequence to obtain the plurality of special effect images.

3. The method according to claim 1, wherein the first special effect generation model is trained by:
obtaining person portrait sample data;
inputting the person portrait sample data and key point difference information into a second special effect generation model, to obtain first special effect data;
encoding the first special effect data to obtain special effect information corresponding to the first special effect data;
inputting the person portrait sample data and the special effect information into the first special effect generation model, to obtain second special effect data; and
training the first special effect generation model based on a loss function between the first special effect data and the second special effect data.

4. The method according to claim 3, wherein obtaining the person portrait sample data comprises:
acquiring a real person portrait to obtain the person portrait sample data; or
rendering a virtual person portrait to obtain the person portrait sample data; or
inputting random noise into a person portrait generation model to obtain the person portrait sample data.

5. The method according to claim 3, wherein the second special effect generation model is trained by:
obtaining virtual person special effect video data and real person special effect video data;
extracting two video frames from the virtual person special effect video data to form a virtual video frame pair, and extracting two video frames from the real person special effect video data to form a real video frame pair;
training the second special effect generation model based on the virtual video frame pair; and
rectifying the trained second special effect generation model based on the real video frame pair.

6. The method according to claim 5, wherein the virtual video frame pair comprises a forward virtual video frame and a backward virtual video frame; and training the second special effect generation model based on the virtual video frame pair comprises:
extracting key point information from each of the forward virtual video frame and the backward virtual video frame to obtain forward virtual key point information and backward virtual key point information;
determining first difference information between the forward virtual key point information and the backward virtual key point information;
inputting the first difference information and the forward virtual video frame into the second special effect generation model, to obtain third special effect data; and
training the second special effect generation model based on a loss function between the backward virtual video frame and the third special effect data.

7. The method according to claim 5, wherein the real video frame pair comprises a forward real video frame and a backward real video frame, and rectifying the trained second special effect generation model based on the real video frame pair comprises:
extracting key point information from each of the forward real video frame and the backward real video frame to obtain forward real key point information and backward real key point information;
determining second difference information between the forward real key point information and the backward real key point information;
inputting the second difference information and the forward real video frame into the trained second special effect generation model, to obtain fourth special effect data; and
rectifying the trained second special effect generation model based on a loss function between the backward real video frame and the fourth special effect data.

8. The method according to claim 5, wherein the first special effect generation model and the second special effect generation model are both constructed using a generative adversarial network, and meet at least one of the following: a number of channels of the first special effect generation model is less than that of the second special effect generation model;
and a number of network layers of the first special effect generation model is less than that of the second special effect generation model.

9. (canceled)

10. An electronic device, comprising:
at least one processing apparatus;
a storage apparatus configured to store at least one program, wherein
the at least one program, when executed by the at least one processing apparatus, causes the at least one processing apparatus to:
acquire one person portrait image or a plurality of person portrait images, and obtaining a special effect information sequence, wherein special effect information in the special effect information sequence is arranged in a set order;
input the one person portrait image and the special effect information sequence into a first special effect generation model, or inputting the plurality of person portrait images and the special effect information sequence into the first special effect generation model, to obtain a plurality of special effect images; and
stitch the plurality of special effect images in the set order, to obtain a target special effect video.

11. A non-transitory computer-readable medium having stored thereon a computer program that, when executed by a processing apparatus, are configurable to cause the processing apparatus to:
acquire one person portrait image or a plurality of person portrait images, and obtaining a special effect information sequence, wherein special effect information in the special effect information sequence is arranged in a set order;
input the one person portrait image and the special effect information sequence into a first special effect generation model, or inputting the plurality of person portrait images and the special effect information sequence into the first special effect generation model, to obtain a plurality of special effect images; and
stitch the plurality of special effect images in the set order, to obtain a target special effect video.

12. (canceled)

13. The electronic device according to claim 10, wherein to train the first special effect generation model, the at least one processing apparatus is caused to:
obtain person portrait sample data;
input the person portrait sample data and key point difference information into a second special effect generation model, to obtain first special effect data;
encode the first special effect data to obtain special effect information corresponding to the first special effect data;
inputting the person portrait sample data and the special effect information into the first special effect generation model, to obtain second special effect data; and
train the first special effect generation model based on a loss function between the first special effect data and the second special effect data.

14. The electronic device according to claim 13, wherein obtaining the person portrait sample data comprises:
acquiring a real person portrait to obtain the person portrait sample data; or
rendering a virtual person portrait to obtain the person portrait sample data; or
inputting random noise into a person portrait generation model to obtain the person portrait sample data.

15. The electronic device according to claim 13, wherein to train the second special effect generation model, the at least one processing apparatus is caused to:
obtain virtual person special effect video data and real person special effect video data;
extract two video frames from the virtual person special effect video data to form a virtual video frame pair, and extracting two video frames from the real person special effect video data to form a real video frame pair;
train the second special effect generation model based on the virtual video frame pair; and
rectify the trained second special effect generation model based on the real video frame pair.

16. The electronic device according to claim 15, wherein the virtual video frame pair comprises a forward virtual video frame and a backward virtual video frame; and training the second special effect generation model based on the virtual video frame pair comprises:
extracting key point information from each of the forward virtual video frame and the backward virtual video frame to obtain forward virtual key point information and backward virtual key point information;
determining first difference information between the forward virtual key point information and the backward virtual key point information;
inputting the first difference information and the forward virtual video frame into the second special effect generation model, to obtain third special effect data; and
training the second special effect generation model based on a loss function between the backward virtual video frame and the third special effect data.

17. The electronic device according to claim 15, wherein the real video frame pair comprises a forward real video frame and a backward real video frame, and rectifying the trained second special effect generation model based on the real video frame pair comprises:
extracting key point information from each of the forward real video frame and the backward real video frame to obtain forward real key point information and backward real key point information;
determining second difference information between the forward real key point information and the backward real key point information;
inputting the second difference information and the forward real video frame into the trained second special effect generation model, to obtain fourth special effect data; and
rectifying the trained second special effect generation model based on a loss function between the backward real video frame and the fourth special effect data.

18. The non-transitory computer-readable medium according to claim 11, wherein to train the first special effect generation model, the processing apparatus is caused to:
obtain person portrait sample data;
input the person portrait sample data and key point difference information into a second special effect generation model, to obtain first special effect data;
encode the first special effect data to obtain special effect information corresponding to the first special effect data;
input the person portrait sample data and the special effect information into the first special effect generation model, to obtain second special effect data; and
train the first special effect generation model based on a loss function between the first special effect data and the second special effect data.

19. The non-transitory computer-readable medium according to claim 18, wherein to train the second special effect generation model, the processing apparatus is caused to:
obtain virtual person special effect video data and real person special effect video data;
extract two video frames from the virtual person special effect video data to form a virtual video frame pair, and extracting two video frames from the real person special effect video data to form a real video frame pair;
train the second special effect generation model based on the virtual video frame pair; and
rectify the trained second special effect generation model based on the real video frame pair.

20. The non-transitory computer-readable medium according to claim 19, wherein the virtual video frame pair comprises a forward virtual video frame and a backward virtual video frame; and training the second special effect generation model based on the virtual video frame pair comprises:
extracting key point information from each of the forward virtual video frame and the backward virtual video frame to obtain forward virtual key point information and backward virtual key point information;
determining first difference information between the forward virtual key point information and the backward virtual key point information;
inputting the first difference information and the forward virtual video frame into the second special effect generation model, to obtain third special effect data; and
training the second special effect generation model based on a loss function between the backward virtual video frame and the third special effect data.

21. The non-transitory computer-readable medium according to claim 19, wherein the real video frame pair comprises a forward real video frame and a backward real video frame, and rectifying the trained second special effect generation model based on the real video frame pair comprises:
extracting key point information from each of the forward real video frame and the backward real video frame to obtain forward real key point information and backward real key point information;
determining second difference information between the forward real key point information and the backward real key point information;
inputting the second difference information and the forward real video frame into the trained second special effect generation model, to obtain fourth special effect data; and
rectifying the trained second special effect generation model based on a loss function between the backward real video frame and the fourth special effect data.

22. The non-transitory computer-readable medium according to claim 19, wherein the first special effect generation model and the second special effect generation model are both constructed using a generative adversarial network, and meet at least one of the following: a number of channels of the first special effect generation model is less than that of the second special effect generation model; and a number of network layers of the first special effect generation model is less than that of the second special effect generation model.
